(19) United States
(12) Patent Application Publication
(10) Pub. No.: US 2023/0308020 A1
(43) Pub. Date: Sep. 28, 2023

(54) BOOST CONVERTER

(71) Applicant: Acer Incorporated, New Taipei City (TW)

(72) Inventor: Tzu-Tseng Chan, New Taipei City (TW)

(73) Assignee: Acer Incorporated, New Taipei City (TW)

(21) Appl. No.: 18/187,687

(22) Filed: Mar. 22, 2023

(30) Foreign Application Priority Data
Mar. 25, 2022 (TW) 111111293

(51) Int. Cl. H02M 3/158; H02M 3/00

(52) U.S. Cl. CPC H02M 3/158; H02M 3/01

(57) ABSTRACT

A boost converter is provided. The boost converter includes a boost inductor, a blocking diode, a power switch, an output diode, an output capacitor, and a first auxiliary path. A first terminal of the boost inductor receives a rectified voltage signal. An anode of the blocking diode is coupled to a second terminal of the boost inductor. The power switch is coupled between the cathode of the blocking diode and a reference low voltage. The anode of the output diode is coupled to the second terminal of the boost inductor. The cathode of the output diode serves as the output terminal of the boost converter. The output capacitor is coupled between the cathode of the output diode and the reference low voltage. When the power switch is turned off, the first auxiliary path is conducted to delay a discharge of the boost inductor.

### CROSS-REFERENCE TO RELATED APPLICATION

This application claims the priority benefit of Taiwan application serial no. 111111293, filed on Mar. 25, 2022. The entirety of the above-mentioned patent application is hereby incorporated by reference herein and made a part of this specification.

### BACKGROUND

### Technology Field

The disclosure relates to the field of power conversion, and particularly, to a boost converter.

### Description of Related Art

FIG. 1 illustrates a conventionally used boost converter 10. FIG. 2 illustrates a schematic view of a waveform of a boost inductor current. The boost converter 10 includes a rectifier RF, a boost inductor LM, a power switch Q, an output diode DO, and an output capacitor CO. The rectifier RF rectifies an input voltage signal VIN to generate a rectified voltage signal VR. The first terminal of the boost inductor LM is coupled to the rectifier RF to receive the rectified voltage signal VR. The first terminal of the power switch Q is coupled to the second terminal of the boost inductor LM. The second terminal of the power switch Q is coupled to the reference low voltage (e.g., ground). The power switch Q operates based on a switching signal GD1. The anode of the output diode DO is coupled to the second terminal of the boost inductor LM. The cathode of the output diode DO is configured to provide an output voltage signal VOUT. The output capacitor CO is coupled between the cathode of the output diode DO and the reference low voltage.

Note that as soon as the current value of a boost inductor current ILM decreases to 0 ampere in the boost converter 10, parasitic capacitance COSS of the power switch Q may resonate with the boost inductor LM, so that the boost inductor current ILM has a reverse inductor current (as shown in areas B1 and B2). The reverse inductor current is dissipated as heat, i.e., a heat loss. The generation of heat losses may decrease the power conversion efficiency. Therefore, how to prevent the generation of the reverse inductor current to improve the power conversion efficiency is one of the research directions of those skilled in the art.

### SUMMARY

The disclosure provides a boost converter capable of preventing the generation of a reverse inductor current to improve the power conversion efficiency.

The boost converter of the disclosure includes a boost inductor, a blocking diode, a power switch, an output diode, an output capacitor, and a first auxiliary path. The first terminal of the boost inductor is configured to receive a rectified voltage signal. The anode of the blocking diode is coupled to the second terminal of the boost inductor. The first terminal of the power switch is coupled to the cathode of the blocking diode. The second terminal of the power switch is coupled to a reference low voltage. The power switch operates based on a first switching signal. The anode of the output diode is coupled to the second terminal of the boost inductor. The cathode of the output diode serves as the output terminal of the boost converter. The output capacitor is coupled between the cathode of the output diode and the reference low voltage. The first auxiliary path is coupled between the second terminal of the boost inductor and the cathode of the output diode. When the power switch is turned off, the first auxiliary path is conducted to delay the discharge of the boost inductor.

In summary, when the power switch is turned off, the blocking diode can prevent the energy stored in the parasitic capacitance of the power switch from returning to the boost inductor. Accordingly, the boost inductor does not generate reverse inductor current. In addition, when the power switch is turned off, the first auxiliary path is conducted to delay the discharge of the boost inductor. Therefore, the time interval in which the current of the boost inductor is decreased to 0 ampere can be greatly shortened. The chance of unintended resonance of the boost inductor LM can be greatly reduced. Accordingly, the power conversion efficiency can be improved.

In order to make the features and advantages of the disclosure comprehensible, embodiments accompanied with drawings are described in detail below.

### BRIEF DESCRIPTION OF THE DRAWING

FIG. 1 is a schematic view of a boost converter according to prior art.

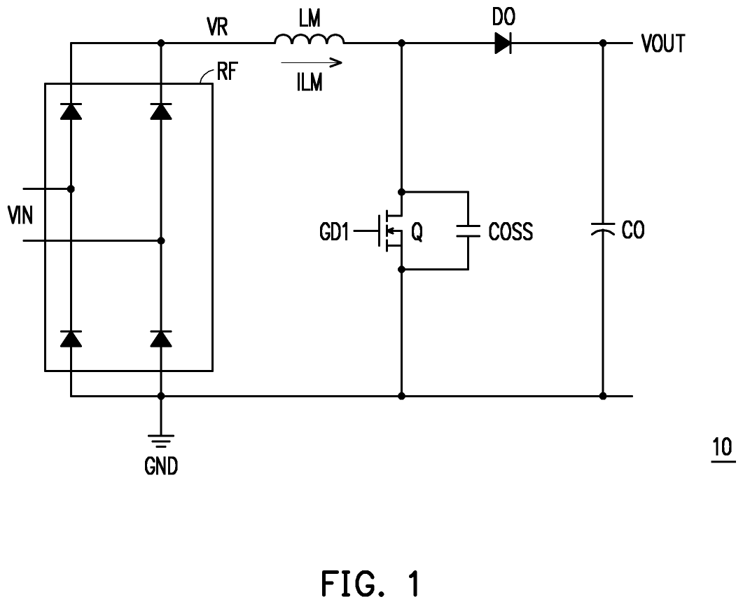

FIG. 2 is a schematic view illustrating a waveform of a boost inductor current according to prior art.

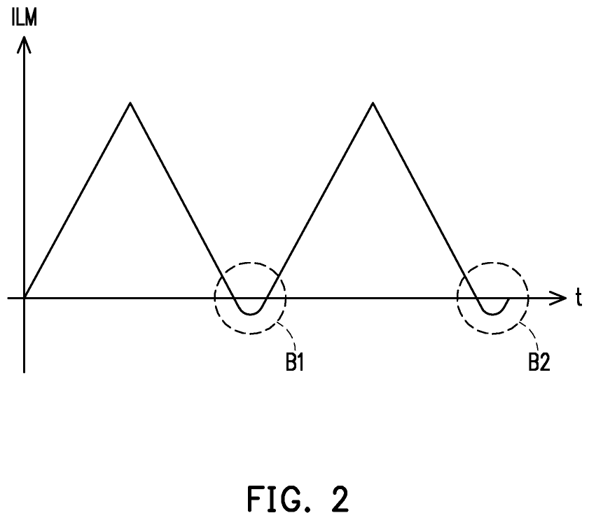

FIG. 3 is a schematic view of a boost converter according to a first embodiment of the disclosure.

FIG. 4 is a schematic view of a waveform of a boost inductor current according to an embodiment of the disclosure.

FIG. 5 is a schematic view of a boost converter according to a second embodiment of the disclosure.

FIG. 6 is a schematic view of waveforms of switching signals according to an embodiment of the disclosure.

FIG. 7 is a schematic view of a boost converter according to a third embodiment of the disclosure.

### DESCRIPTION OF THE EMBODIMENTS

Some embodiments of the disclosure will be described in detail with reference to the accompanying drawings. For reference numerals cited in the following descriptions, the same reference numerals appearing in different drawings are regarded as the same or similar elements. The embodiments are only a part of the disclosure and do not disclose all possible implementations of the disclosure. More precisely, the embodiments are merely examples of the device and the method.

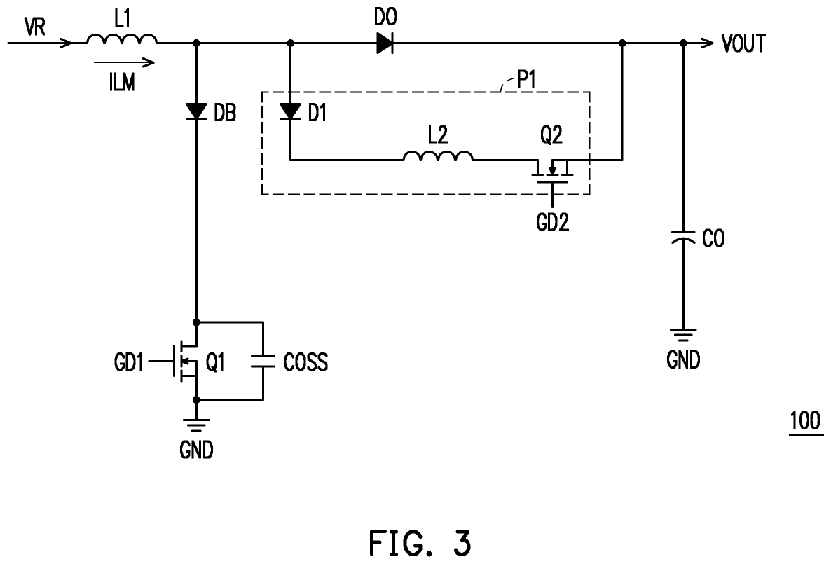

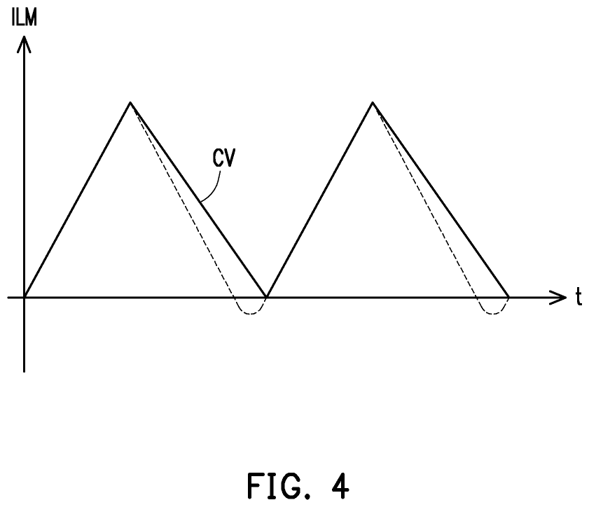

Referring to both FIG. 3 and FIG. 4, FIG. 3 is a schematic view of a boost converter according to a first embodiment of the disclosure. FIG. 4 is a schematic view of a waveform of a boost inductor current according to an embodiment of the disclosure. In the embodiment, the boost converter 100 can convert the rectified voltage signal VR to generate the output voltage signal VOUT. The boost converter 100 includes a boost inductor L1, a blocking diode DB, a power switch Q1, the output diode DO, the output capacitor CO, and a first auxiliary path P1. The first terminal of the boost inductor L1 is configured for receiving the rectified voltage signal VR. The anode of a blocking diode DB1 is coupled to the second terminal of the boost inductor L1. The first terminal of the power switch Q1 is coupled to the cathode of the blocking diode DB. The second terminal of the power switch Q1 is coupled to the reference low voltage (e.g., the ground terminal GND). The power switch Q1 operates based on the switching signal GD1. The power switch Q1 performs switching operations based on the voltage level of the switching signal GD1. The anode of the output diode DO is coupled to the second terminal of the boost inductor L1. The cathode of the output diode DO serves as the output terminal of the boost converter 100 to provide the output voltage signal VOUT. The output capacitor CO is coupled between the cathode of the output diode DO and the reference low voltage. The first auxiliary path P1 is coupled between the second terminal of the boost inductor L1 and the cathode of the output diode DO.

In the embodiment, when the power switch Q1 is turned on, the boost inductor L1 may receive the rectified voltage signal VR and store the energy from the rectified voltage signal VR. Therefore, a boost inductor current ILM at the boost inductor L1 increases. In addition, when the power switch Q1 is turned on, the first auxiliary path P1 is not conducted.

When the power switch Q1 is turned off, the boost inductor L1 may discharge the energy stored in the boost inductor L1 itself. The first auxiliary path P1 is conducted and enabled. The energy stored in the boost inductor L1 may reach the output capacitor CO through two paths, such as the output diode DO and the first auxiliary path P1. The first auxiliary path P1 is configured to delay the discharge of the boost inductor L1. Therefore, the rate at which the boost inductor L1 discharges energy decreases, as shown by the curve CV. Accordingly, the chance of unintended resonance of the boost inductor L1 can be greatly reduced. Besides, the blocking diode DB prevents the energy stored in the parasitic capacitance COSS of the power switch Q1 from returning to the boost inductor L1. The boost inductor L1 generates no reverse inductor currents. Therefore, the power conversion efficiency of the boost converter 100 can be improved.

In the embodiment, the first auxiliary path P1 includes a diode D1, an inductor L2, and a switch Q2. The anode of the diode D1 is coupled to the second terminal of the boost inductor L1. The switch Q2 and the inductor L2 are coupled in series between the cathode of the diode D1 and the cathode of the output diode DO. The switch Q2 operates based on a switching signal GD2. For example, the first terminal of the inductor L2 is coupled to the cathode of the diode D1. The first terminal of the switch Q2 is coupled to the second terminal of the inductor L2. The second terminal of the switch Q2 is coupled to the cathode of the output diode DO. The control terminal of the switch Q2 is configured to receive the switching signal GD2. In the embodiment, when the power switch Q1 is turned off, the switch Q2 is turned on. Therefore, the first auxiliary path P1 may be conducted and enabled. The inductor L2 may provide inductive reactance value. Therefore, when the power switch Q1 is turned off, the inductive reactance value of the boost converter 100 increases, and thereby the discharge of the boost inductor L1 is delayed. The diode D1 is configured to define the transfer direction of the energy, thereby preventing the energy from returning to the boost inductor L1 when the first auxiliary path P1 is conducted.

On the other hand, when the power switch Q1 is turned on, the switch Q2 is turned off. Therefore, the first auxiliary path P1 may not be conducted and disabled.

In the embodiment, the power switch Q1 and the switch Q2 are respectively implemented by N-type metal-oxide-semiconductor field-effect transistors (MOSFETs). However, the disclosure is not limited thereto. The power switch Q1 and the switch Q2 may be implemented by transistor switches well-known to those skilled in the art.

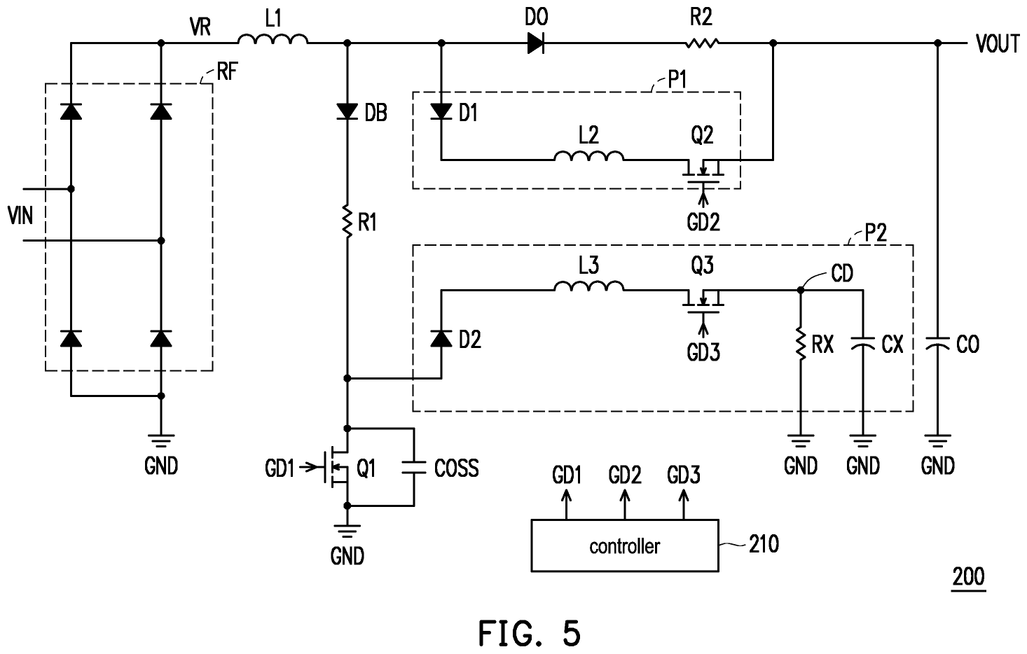

Referring to FIG. 5, FIG. 5 is a schematic view of a boost converter according to a second embodiment of the disclosure. In the embodiment, a boost converter 200 includes the boost inductor L1, the blocking diode DB, the power switch Q1, the output diode DO, the output capacitor CO, the first auxiliary path P1, and a second auxiliary path P2. In the embodiment, the implementation of the boost inductor L1, the blocking diode DB, the power switch Q1, the output diode DO, the output capacitor CO and the first auxiliary path P1 can be obtained from the sufficient teaching of the first embodiment of FIG. 3, which is not repeated herein. In the embodiment, the second auxiliary path P2 is coupled between the first terminal of the power switch Q1 and the reference low voltage. When the power switch Q1 is turned off, the second auxiliary path P2 is conducted to discharge the energy stored in the parasitic capacitance COSS of the power switch Q1.

In the embodiment, the second auxiliary path P2 includes a diode D2, a resonant resistor RX, a resonant capacitor CX, an inductor L3, and a switch Q3. The anode of the diode D2 is coupled to the first terminal of the power switch Q1. The resonant capacitor CX and the resonant resistor RX are connected in parallel between a connection node CD and the reference low voltage. The switch Q3 and the inductor L3 are coupled in series between the cathode of the diode D2 and the connection node CD. The switch Q3 operates based on a switching signal GD3. For example, the first terminal of the inductor L3 is coupled to the cathode of the diode D2. The first terminal of the switch Q3 is coupled to the second terminal of the inductor L3. The second terminal of the switch Q3 is coupled to the connection node CD. The control terminal of the switch Q3 is configured to receive the switching signal GD3. In the embodiment, when the power switch Q1 is turned off, the switch Q3 is turned on. Therefore, the second auxiliary path P2 is conducted and enabled. Therefore, the parasitic capacitance COSS of the power switch Q1, the inductor L3, the resonant capacitor CX, and the resonant resistor RX form a resonance circuit. Accordingly, the energy stored in the parasitic capacitance COSS of the power switch Q1 may be discharged to the reference low voltage through the resonance circuit. The diode D2 is configured to define the transfer direction of the energy, so as to prevent the energy from returning to the parasitic capacitance COSS when the second auxiliary path P2 is conducted.

On the other hand, when the power switch Q1 is turned on, the switch Q3 is turned off. Therefore, the second auxiliary path P2 is not conducted and disabled. Meanwhile, the energy stored in the resonant capacitor CX is discharged to the reference low voltage through the resonant resistor RX.

In the embodiment, the switch Q3 is implemented by an N-type MOSFET. However, the disclosure is not limited thereto. The switch Q3 may be implemented by a transistor switch well-known to those skilled in the art.

In the embodiment, the boost converter 200 also includes a rectifier RF. The rectifier RF is coupled to the first terminal of the boost inductor L1. The rectifier RF receives an input voltage signal VIN. The rectifier RF rectifies the input voltage signal VIN to generate a rectified voltage signal VR. In the embodiment, the rectifier RF may be implemented by a full bridge rectifier. In some embodiments, the rectifier RF may be disposed outside the boost converter 200.

In the embodiment, the boost converter 200 further includes resistors R1 and R2. The resistor R1 is coupled between the cathode of the blocking diode DB and the first terminal of the power switch Q1. The resistor R2 is coupled between the cathode of the output diode DO and the output terminal of the boost converter 200. The resistor R1 is configured to adjust the rate at which the boost inductor L1 stores energy. The resistor R2 is configured to assist in adjusting the rate at which the boost inductor L1 discharges energy.

In the embodiment, the boost converter 200 further includes a controller 210. The controller 210 provides the switching signals GD1, GD2, and GD3.

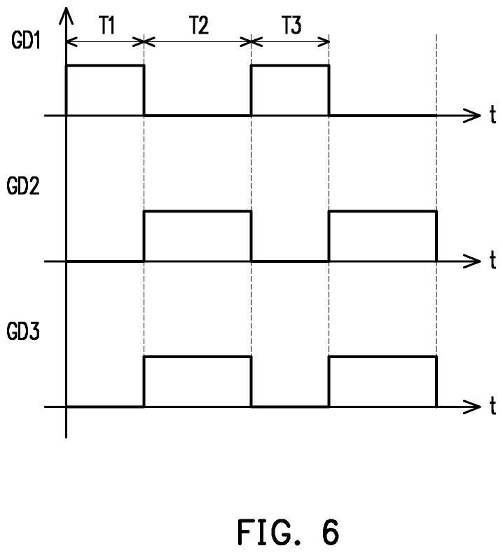

Next, referring to both FIG. 5 and FIG. 6, FIG. 6 is a schematic view of waveforms of switching signals according to an embodiment of the disclosure. FIG. 6 illustrates the switching signals GD1, GD2, and GD3. In the embodiment, the power switch Q1 is turned on in response to the switching signal GD1 having a high voltage level. The power switch Q1 is turned off in response to the switching signal GD1 having a low voltage level. The switch Q2 is turned on in response to the switching signal GD2 having a high voltage level. The switch Q2 is turned off in response to the switching signal GD2 having a low voltage level. The switch Q3 is turned on in response to the switching signal GD3 having a high voltage level. The switch Q3 is turned off in response to the switching signal GD3 having a low voltage level. In the embodiment, the states of the switching signals GD2 and GD3 are controlled to be opposite to the state of the switching signal GD1. That is, when the switching signal GD1 is at a high voltage level, the switching signals GD2 and GD3 are at a low voltage level. On the other hand, when the switching signal GD1 is at a low voltage level, the switching signals GD2 and GD3 are at a high voltage level.

In the embodiment, in a time interval Ti, the power switch Q1 is turned on in response to the switching signal GD1 having a high voltage level. The boost inductor L1 may store the energy from the rectified voltage signal VR. Therefore, the boost inductor current ILM at the boost inductor L1 increases. The parasitic capacitance COSS of the power switch Q1 also stores energy. In the time interval T1, the first auxiliary path P1 and the second auxiliary path P2 are not conducted.

In a time interval T2, the power switch Q1 is turned off in response to the switching signal GD1 having a low voltage level. The boost inductor L1 discharges energy. Meanwhile, the first auxiliary path P1 and the second auxiliary path P2 are conducted. Therefore, the discharge of the boost inductor L1 may be delayed. In addition, the energy stored in the parasitic capacitance COSS is also discharged through the second auxiliary path P2. When the current value of the boost inductor current ILM of the boost inductor L1 is decreased to 0 ampere, the blocking diode DB may prevent the energy stored in the parasitic capacitance COSS from returning to the boost inductor L1.

In a time interval T3, the power switch Q1 is turned on in response to the switching signal GD1 having a high voltage level. The first auxiliary path P1 and the second auxiliary path P2 are not conducted. The boost inductor L1 may store the energy from the rectified voltage signal VR. In addition, the energy stored in the resonant capacitor CX is discharged to the reference low voltage through the resonant resistor RX.

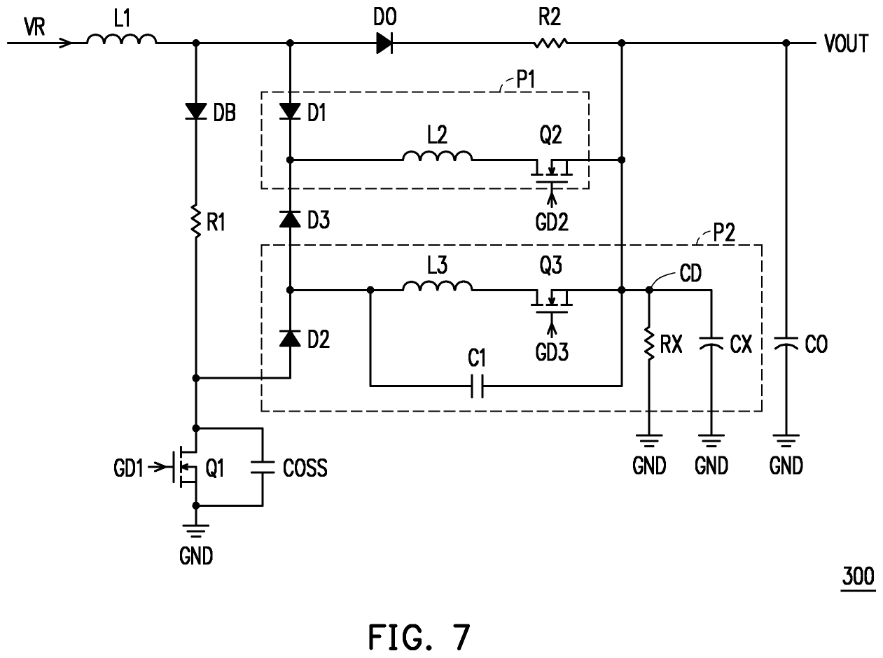

Referring to FIG. 7, FIG. 7 is a schematic view of a boost converter according to a third embodiment of the disclosure. Different from the second embodiment of FIG. 5, a boost converter 300 also includes a diode D3. The anode of the diode D3 is coupled to the cathode of the diode D2. The cathode of the diode D3 is coupled to the cathode of the diode D1. Furthermore, the connection node is coupled to the cathode of the output diode. Therefore, when the power switch Q1 is turned off, the parasitic capacitance COSS, the inductors L2 and L3, the resonant capacitor CX, and the resonant resistor RX together form a resonance circuit. This resonance circuit may discharge the energy stored in the parasitic capacitance COSS to the reference low voltage. That is, the energy stored in the parasitic capacitance COSS may be discharged to the reference low voltage through a part (the inductor L2) of the first auxiliary path P1 and the second auxiliary path P2.

In the embodiment, the boost converter 300 further includes a balance capacitor C1. The balance capacitor C1 is coupled between the cathode of the diode D3 and the connection node CD. The balance capacitor C1 provides a capacitive reactance value to offset the inductive reactance value generated by the boost inductor L1 and the inductors L2 and L3.

When having large output power (e.g., greater than or equal to 180 watts), the boost inductor current ILM at the boost inductor L1 is likely to have not been completely discharged (the current value of the boost inductor current ILM is decreased to 0 ampere), and then the power switch Q1 is turned on. In such a case, an erroneous operation of the state transition of the boost converter 300 may occur. In the embodiment, the balance capacitor C1 is configured to offset the inductive reactance value jointly generated by the boost inductor L1 and the inductors L2 and L3. Accordingly, the slow discharge rate of the boost inductor current ILM can be accelerated.

In summary, when the power switch is turned off, the boost inductor may discharge the energy stored in the boost inductor itself. The first auxiliary path is conducted and enabled. The first auxiliary path is configured to delay the discharge of the boost inductor. Therefore, the rate at which the boost inductor discharges energy is decreased. The chance of unintended resonance of the boost inductor can be greatly reduced. In addition, the blocking diode prevents the energy stored in the parasitic capacitance of the power switch from returning to the boost inductor. The boost inductor does not generate reverse inductor current. Accordingly, the power conversion efficiency can be improved. Furthermore, when the power switch is turned off, the second auxiliary path is turned on to discharge the energy stored in the parasitic capacitance of the power switch.

Although the disclosure has been described with reference to the above embodiments, they are not intended to limit the disclosure. It will be apparent to one of ordinary skill in the art that modifications and changes to the described embodiments may be made without departing from the spirit and the scope of the disclosure. Accordingly, the scope of the disclosure will be defined by the attached claims and their equivalents and not by the above detailed descriptions.

What is claimed is:

1. A boost converter comprising:
a boost inductor, wherein a first terminal of the boost inductor is configured to receive a rectified voltage signal;
a blocking diode, wherein an anode of the blocking diode is coupled to a second terminal of the boost inductor;
a power switch, wherein a first terminal of the power switch is coupled to a cathode of the blocking diode, a second terminal of the power switch is coupled to a reference low voltage, and the power switch operates based on a first switching signal;
an output diode, wherein an anode of the output diode is coupled to the second terminal of the boost inductor, and a cathode of the output diode serves as an output terminal of the boost converter;
an output capacitor, coupled between the cathode of the output diode and the reference low voltage; and
a first auxiliary path, coupled between the second terminal of the boost inductor and the cathode of the output diode, and configured to be turned on when the power switch is turned off, thereby delaying a discharge of the boost inductor.

2. The boost converter according to claim 1, wherein the first auxiliary path comprises:
a first diode, wherein an anode of the first diode is coupled to the second terminal of the boost inductor;
a first inductor; and
a first switch, coupled in series to the first inductor between a cathode of the first diode and the cathode of the output diode, and configured to operate based on a second switching signal.

3. The boost converter according to claim 2, wherein the first switch is turned on when the power switch is turned off.

4. The boost converter according to claim 2, further comprising:
a second auxiliary path, coupled between the first terminal of the power switch and the reference low voltage, and configured to be turned on when the power switch is turned off, thereby discharging energy stored in parasitic capacitance of the power switch.

5. The boost converter according to claim 4, wherein the second auxiliary path comprises:
a second diode, wherein an anode of the second diode is coupled to the first terminal of the power switch;
a resonant resistor;
a resonant capacitor, connected in parallel to the resonant resistor between a connection node and the reference low voltage;
a second inductor; and
a second switch, coupled in series to the second inductor between a cathode of the second diode and the connection node, and configured to operate based on a third switching signal.

6. The boost converter according to claim 5, wherein the second switch is turned on when the power switch is turned off.

7. The boost converter according to claim 5, further comprising:
a third diode, wherein an anode of the third diode is coupled to the cathode of the second diode, and a cathode of the third diode is coupled to the cathode of the first diode,
wherein the connection node is coupled to the cathode of the output diode.

8. The boost converter according to claim 7, wherein when the power switch is turned off, the parasitic capacitance of the power switch, the first inductor, the second inductor, the resonant capacitor, and the resonant resistor together form a resonance circuit.

9. The boost converter according to claim 5, wherein when the second auxiliary path is not conducted, energy stored in the resonant capacitor is discharged to the reference low voltage through the resonant resistor.

10. The boost converter according to claim 5, further comprising:
a balance capacitor, coupled between the cathode of the second diode and the connection node and configured to provide a capacitive reactance value,
wherein the capacitive reactance value is used for offsetting an inductive reactance value generated by the boost inductor, the first inductor, and the second inductor.
